(19) United States
(12) Patent Application Publication
(10) Pub. No.: US 2008/0320538 A1
(43) Pub. Date: Dec. 25, 2008

(54) METHODS AND SYSTEMS FOR TRANSMITTING AND ACCESSING VIDEO DATA

(76) Inventor: Gad Liwerant, Chestnut Hill, MA (US)

Correspondence Address: STRATEGIC PATENTS P.C.., C/O PORTFOLIOIP, P.O. BOX 52050, MINNEAPOLIS, MN, 55402, US

(21) Appl. No.: 12/103,797

(22) Filed: Apr. 16, 2008

Related U.S. Application Data
(60) Provisional application No. 60/912,062, filed on Apr. 16, 2007.

(51) Int. Cl. H04N 7/173

(52) U.S. Cl. 725/118

(57) ABSTRACT

In embodiments of the present invention improved methods and systems are described for transmitting and accessing video data. The methods and systems may include capturing and streaming live video data from any point at any time in real time. The capturing and streaming of the video data may be done remotely. The video data may be transmitted wirelessly to any location in real-time. Transmitting the video data wirelessly may include uploading the video data, wirelessly streaming the video data or transmitting the video data using some other type of method. The transmitted video data may be accessed by one or more users of one or more electronic devices.

### CROSS-REFERENCE TO RELATED APPLICATIONS

This application claims the benefit of the following provisional application, which is hereby incorporated by reference in its entirety:

U.S. Provisional App. No. 60/912,062 filed Apr. 16, 2007.

### BACKGROUND

1. Field:

The present invention is related to transmitting and accessing video data, and more specifically relating to remote transmission of video data wirelessly.

2. Description of the Related Art

Currently used wireless devices have capabilities for capturing media data such as audio and video data. In addition, wireless devices may have capabilities for transmission of video data. One of the methods used for video transmission using wireless devices may include video streaming. An example of video streaming may be sending images in compressed form over the Internet for a viewer to view on a computer. Currently used video streaming activities may not support real-time video streaming to any location and at any point in time. There exists a need for an improved method for capturing and streaming video data remotely at any point in time in any location.

### SUMMARY

The present invention provides improved methods and systems for transmitting and accessing video data. The methods and systems may include capturing and streaming live video data from any point at any time in real time. The capturing and streaming of the video data may be done remotely. The video data may be transmitted wirelessly to any location in real-time. Transmitting the video data wirelessly may include uploading the video data, wirelessly streaming the video data or transmitting the video data using some other type of method. The transmitted video data may be accessed by one or more users of one or more electronic devices.

In embodiments, the one or more electronic devices may be a wired device, a wireless device or some other type of electronic device.

In embodiments, the video data may be transmitted wirelessly using a wireless network. The wireless network may be a high-speed wireless network, a low-speed wireless network or some other type of wireless network.

In embodiments, the video data may be transmitted to a single point or multiple points.

In embodiments, users of an electronic device may able to share video data on the fly, wirelessly at any time and location. The users may be able to view the video data in real-time, share the video data in real-time and the like. For example, the users may be able to share their experiences remotely, wirelessly and in real-time. The users may be able to access transmitted video segments instantly in real-time.

These and other systems, methods, objects, features, and advantages of the present invention will be apparent to those skilled in the art from the following detailed description of the preferred embodiment and the drawings. All documents mentioned herein are hereby incorporated in their entirety by reference.

### BRIEF DESCRIPTION OF THE FIGURES

The invention and the following detailed description of certain embodiments thereof may be understood by reference to the following FIGURES:

FIG. 1 depicts a system for transmitting and accessing video data wirelessly in real-time in an embodiment of the present invention.

### DETAILED DESCRIPTION

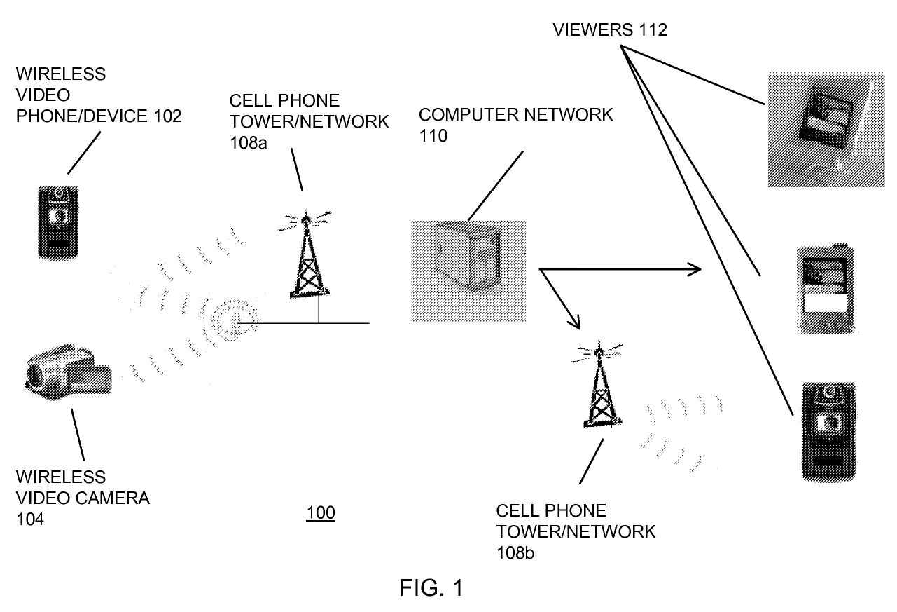

FIG. 1 depicts a system 100 for transmitting and accessing video data wirelessly in real-time in an embodiment of the present invention. The system 100 may include a wireless video phone/device 102, a wireless video camera 104, cell phone tower/networks 108a and 108b, a computer network 110 and viewers 112.

A user may use the wireless video phone/device 102 to capture a live video segment. An example of the wireless video phone/device may be a video capture enabled cell phone. In an embodiment, the user may capture the live video segment remotely in real-time. The user may use the wireless video camera 104 to capture the live video segment. The wireless video camera may be a video camera with cell network connection capabilities. Capturing the live video segment may include capturing one or more video segments. An example of capturing one or more video segments may be capturing live feeds of video by college students using wireless video capable mobile phones. The live feeds of video may be captured from a bar, a campus, a weekend getaway and the like. An example of a live video feed captured by college students may be capturing the environment, the activities and the surroundings in the bar. An example of a live video feed captured from a weekend getaway may be capturing the activities, the slopes by the user of a wireless video camera on a skiing trip.

The user may transmit a captured live video segment wirelessly. In an embodiment, the user may upload or stream the live video segment from any point to any location in real time. In embodiments, the live video segment may be streamed by sending it through a wireless network. As shown in the FIG. 1, the live video segment may be sent through the cell phone tower/network 108a. The cell phone tower/network 108a may be a General Packet Radio Service (GPRS) network, a 3G network, a Global System for Mobile Communications (GSM) network, a Wi-Fi network or some other type of network. In an example, the cell phone tower/network 108a may be a high-speed wireless network.

In embodiments, the live video segment may be streamed by the cell phone tower/network 108a through related wired network infrastructure. The cell phone tower/network 108a may be connected to a wired network infrastructure like the computer network 110. The computer network 110 may be a local area network (LAN), the Internet connected to a central hub or a central web page and the like.

In embodiments, a user may access the live video segment through the cell phone tower/network 108b. In an embodiment, a single user may be able to access the live video segment. In another embodiment, multiple users may be able to access the live video segment. An example of accessing the live video segment may be using the viewers 112 to view the video segment in real-time. Examples of viewers 112 may be a personal computer (PC), a handheld device, a wired phone, a computer, a television and the like. In embodiments, the live video segment may be accessed by a user using a wireless device like a cell phone, a mobile phone or some other type of wireless device. Examples of multiple users may be friends of college students in a bar who are able to view the activities taking place in the bar in real-time. The friends may be situated remotely and may be able to see the activities instantly through the system 100.

The elements depicted in flow charts and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these, and all such implementations are within the scope of the present disclosure. Thus, while the foregoing drawings and description set forth functional aspects of the disclosed systems, no particular arrangement of software for implementing these functional aspects should be inferred from these descriptions unless explicitly stated or otherwise clear from the context.

Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods or processes described above, and steps thereof, may be realized in hardware, software, or any combination of these suitable for a particular application. The hardware may include a general-purpose computer and/or dedicated computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as computer executable code created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in a number of ways, or all of the functionality may be integrated into a dedicated, standalone device or other hardware. In another aspect, means for performing the steps associated with the processes described above may include any of the hardware and/or software described above. All such permutations and combinations are intended to fall within the scope of the present disclosure.

While the invention has been disclosed in connection with the preferred embodiments shown and described in detail, various modifications and improvements thereon will become readily apparent to those skilled in the art. Accordingly, the spirit and scope of the present invention is not to be limited by the foregoing examples, but is to be understood in the broadest sense allowable by law.

All documents referenced herein are hereby incorporated by reference.

What is claimed is:

1. A method for transmitting and accessing video data, the method comprising:
capturing the video data, wherein the video data is captured using a wireless device;
transmitting the video data, wherein the video data is transmitted by at least one of uploading and streaming the video data through a wireless network; and
accessing the video data by one or more users of one or more electronic devices.

2. The method of claim 1 wherein the one or more electronic devices are wireless devices.

3. The method of claim 1 wherein the wireless network is a high-speed network.

4. The method of claim 1 wherein the one or more users are situated in one or more remote locations.

5. The method of claim 1 wherein the video data is streamed through the wireless network and related wired network infrastructure.
